(19) United States
(12) Patent Application Publication
(10) Pub. No.: US 2025/0155366 A1
(43) Pub. Date: May 15, 2025

(54) PROCESS FOR DETECTING AMINE-TYPE COMPOUNDS IN WATER AND AIR COMPARTMENTS

(71) Applicants: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR); ELECTRICITE DE FRANCE, Paris (FR)

(72) Inventors: Mélanie LORTHIOY, Chatou (FR); Maxime BRETAUD, Chatou (FR); Thu-Hoa TRAN THI, Montrouge (FR); Trung Hieu NGUYEN, Paris (FR); Guillaume LE CHEVALLIER, Gif Sur Yvette Cedex (FR)

(73) Assignees: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR); ELECTRICITE DE FRANCE, Paris (FR)

(21) Appl. No.: 18/934,554

(22) Filed: Nov. 1, 2024

(30) Foreign Application Priority Data
Nov. 9, 2023 (FR) FR2312241

(51) Int. Cl. G01N 21/31; G01N 1/22

(52) U.S. Cl. CPC G01N 21/31; G01N 1/22; G01N 2001/2223; G01N 2021/3125

(57) ABSTRACT

A process for detecting at least one amine-type compound, the compound being chosen from hydrazine, ethanolamine, and morpholine, the process includes using a reagents composition including a mixture of 4-(dimethylamino)cinnamaldehyde and polystyrenesulfonic acid. Also, a kit for preparing the reagents composition, the reagents composition itself, and the uses of the reagents composition.

### FIELD

The present invention relates to a novel process for detecting and optionally quantifying amine-type compounds, in particular hydrazine (N₂H₄), which is suitable for both the water (hydrazine in aqueous solution) and air (hydrazine in the atmosphere) compartments.

### BACKGROUND

Hydrazine is classified as a CMR substance (IARC 2B-UE 11B). In 2011, it was incorporated into the REACH regulation candidate list of substances of very high concern. In 2017, the European Union lowered its TLV (8-hour Occupational Exposure Limit value) by a factor of 10, imposing a new threshold of 10 ppb (0.013 mg/m³), applicable from Jan. 17, 2020 at the latest. In addition to health concerns, hydrazine is also classified as very toxic to aquatic organisms (EU classification H400 and H410).

Due to its CMR nature, hydrazine is no longer an oxidizer for rockets, but is still used in many fields, notably as an organic synthesis intermediate in the pharmaceutical and chemical industries, or as a blowing agent for polymer foams, or as a reducer of metal salts, or even as a corrosion inhibitor in industrial boiler circuit water, for example.

Due to its toxicity, assessing the risks associated with environmental hydrazine releases is important, and requires the ability to detect and optionally quantify the presence of hydrazine in the environment.

To date, this risk assessment is severely limited by the metrology associated with this substance, in particular as regards direct in-situ measurement. Specifically, although relatively sensitive and specific analytical methods do exist (final reading by HPLC-UV), they cannot be readily performed, nor are they compatible with industrial practices. “Instantaneous response” analytical methods are neither sufficiently selective nor sufficiently precise and sensitive to allow expected hydrazine gas concentrations in final discharges to be evaluated.

The process which is a subject of the present invention provides a solution to these problems.

Specifically, the process according to the invention allows hydrazine to be detected and optionally quantified selectively in the presence of potential interferents serving to basify water or derived from hydrazine degradation, such as ethanolamine (NH₂EtOH), morpholine or ammonia (NH₃). The concentrations of NH₂EtOH, morpholine and NH₃ may be up to 100 to 200 times higher than those of hydrazine, without reducing the efficacy and accuracy of the detection process according to the invention.

The reagent used also reacts simultaneously with these other amines, forming colored compounds that are different from the compound formed with hydrazine. The method thus also makes it possible to detect and determine the concentration of ethanolamine or morpholine at the same time as that of hydrazine, which may allow, for example, the correct basification of water to be verified.

Moreover, hydrazine detection and quantification may need to be performed in both the water and air compartments, and the process according to the invention allows this.

In the water compartment, samples need to be collected for analysis without loss of material due to the volatility of the target compound (N₂H₄) and that of the interferents (NH₃, NH₂EtOH, morpholine), for analysis in situ or after a 24-hour delay in the laboratory. The analysis method must be selective toward N₂H₄, whose concentration is up to 100 to 200 times lower than that of the interferents. The concentration range of N₂H₄ in the water compartment may be wide, from 0.2 to 200 μg·L⁻¹ (i.e. 0.2 to 200 ppb).

In the air compartment, ambient air is collected which, in addition to molecular oxygen (O₂), water vapor and VOCs (Volatile Organic Compounds), also contains other nitrogen compounds (N₂H₄, NH₃, NH₂EtOH, morpholine). One of the aims is thus to selectively measure hydrazine gas over a wide concentration range, from 1.3 to 264 μg·m⁻³ (i.e. from 1 to 200 ppb), and also to quantify potential nitrogen interferents. The analysis must be capable of being performed in situ, or after a 24-hour delay in the laboratory.

The detection of hydrazine has been the subject of numerous studies, and detection methods are as numerous as they are varied, due to the high chemical reactivity of this compound. However, most studies have focused either on hydrazine measurement in water or measurement in air. Methods allowing both the water and air compartments to be reached are rare, or even unexplored.

As a result, in the following description of the prior art, the water and air compartments are treated separately, and only methods proposed in the literature that are capable of covering the concentration ranges sought in the water and air compartments are described, i.e. from 0.2 to 200 μg·L⁻¹ (i.e. from 0.2 to 200 ppb) and 1.3 to 264 μg·m⁻³ (i.e. from 1 to 200 ppb) respectively.

### PRIOR ART

### Detection of Hydrazine in Water

As hydrazine is a powerful reducing agent, a good nucleophile and also a base, detection may be obtained using its nucleophilic, reducing or basic properties.

Detection based on the nucleophilic property is the most widely studied method and is based mainly on nucleophilic substitution reactions on a carbonyl group of an aromatic aldehyde forming an absorbent and/or fluorescent colored product. para-Dimethylaminobenzaldehyde (pDMAB) is the method most commonly used industrially. para-Dimethylaminobenzaldehyde reacts with hydrazine in an acidic medium to produce an adduct, p-dimethylaminobenzalazine, which absorbs in the visible range with a maximum centered at 458 nm or 454 nm, depending on the surrounding medium. The molar extinction coefficient of p-dimethylaminobenzalazine is high, around 60 000 L·mol⁻¹·cm⁻¹ [^{1, 2, 3}] and the detection limit of hydrazine with this reagent is 4.7 μg·L⁻¹ when the assay is performed with a 5 cm optical path spectrophotometric cell. As p-dimethylaminobenzalazine is unstable, its detection is limited in time and it is not possible to perform delayed measurements beyond 16 h. Based on this method, reaction modifications have been made by several teams in order to improve the hydrazine detection procedure and/or sensitivity.

George et al. [⁴] improved the sensitivity by producing in situ 2,4-dinitrophenylhydrazine by first reacting hydrazine with 2,4-dinitrochlorobenzene, in the presence of sodium acetate and diethylene glycol. As 2,4-dinitrophenylhydrazine is an excellent reagent for the detection and assay of carbonyl groups, it then reacts with pDMAB in an acidic medium to form yellow-colored hydrazone. The hydrazone absorbing at 458 nm has a very high molar extinction coefficient (ε_{458 nm}≈81 000 L·mol⁻¹·cm⁻¹), allowing the sensitivity of the measurement to be increased. However, this method uses a reprotoxic and carcinogenic compound, 2,4-dinitrochlorobenzene. Moreover, the method is long and complex, as the detection procedure includes five successive steps which are difficult to perform in situ:
1) formation of 2,4-dinitrophenylhydrazine by heating the mixture until the volume is reduced to half the initial volume;
2) reaction of 2,4-dinitrophenylhydrazine with pDMAB;
3) cooling of the mixture to room temperature;
4) formation of the final product by adding HCl;
5) UV-visible assay of the final product at 458 nm.

In the study by Ortega-Barrales et al. [⁵], the sensitivity is improved by assaying the colored product (benzalazine) in solid phase; a Dowex 50 W×8 ion exchange resin is added to the reaction medium to trap and concentrate the benzalazine. The benzalazine binds to the Dowex beads by centrifugation. The resin is then recovered by filtration, and the benzalazine adsorbed on the transparent resin is assayed in the solid phase by spectrophotometry at 464 nm. The detection limit is of the order of 0.016 μg·L⁻¹ for 1 liter of sample. Although this method is very sensitive, its technical nature makes it difficult to use on site.

Other substituted benzaldehydes have also been studied for hydrazine assay, such as vanillin [⁶], veratraldehyde [⁷], 2-hydroxy-1-naphthaldehyde [⁸] and 5-nitro-2-furaldehyde [⁹]. These four probe molecules are less reactive than pDMAB, and the reactions were produced at high temperatures.

In recent years, several teams have developed selective hydrazine detection methods based on fluorescent probes, mainly to determine the presence of hydrazine in drinking water, in raw water (rivers, etc.) and in particular in living cells. Fluorescent probes are generally aromatic polycyclic molecules with one or two electrophilic sites capable of reacting with hydrazine.

Roy et al. [¹⁰], Nguyen et al. [¹¹] published reviews of the various fluorescent probes used for hydrazine detection. With the use of fluorescent probes, it is possible to achieve low limits of hydrazine concentration in water in the ng·L⁻¹ range. The best sensitivities achieved are 35 ng·L⁻¹ [¹² ], 60 ng·L⁻¹ [¹³ ], 280 ng·L⁻¹ [¹⁴] and 300 ng·L⁻¹ [¹⁵] in water. However, the main drawback of fluorescent probes is their availability. Specifically, none of the proposed probes is currently sold. Moreover, the authors do not mention any stability studies on the adducts formed.

Other methods are based on the reducing property of hydrazine in acidic medium. Afkhami et al. [¹⁶] proposed a method for the indirect detection of hydrazine in solution, based on the inhibition of the redox reaction between the bromate ion and hydrochloric acid. In an acidic medium, the bromate ion (BrO₃⁻) is reduced by the chloride ion (Cl⁻) to Br₂. Chlorine and bromine are then measured by decolorization of methyl orange, which absorbs at 525 nm. The presence of hydrazine will have the effect of inhibiting decolorization of the methyl orange. Specifically, as hydrazine is a strong reducing agent, it reacts rapidly with chlorine and bromine to form Cl⁻ and Br⁻ ions. The rate of decolorization is reduced in the presence of hydrazine. This method allows linear determination of 9.6 to 1024 μg·L⁻¹ hydrazine, with a detection limit of 2.72 μg·L⁻¹.

Methyl orange may be replaced with Victoria blue 4R [¹⁷] to obtain similar sensitivity. However, there are interferences: NH₃, a hydrazine interferent, is reactive toward Cl₂ and Br₂, making the method unselective.

Hydrazine may also reduce chlorauric acid molecules (HAuCl₄), inducing the formation of gold nanoparticles, AuNPs, which are stable in the presence of sulfamic acid and whose resonance plasmon is detected in the visible range. Gao et al. [¹⁸] exploited this method by following the growth of AuNPs, whose size increased with the hydrazine concentration. The solution, initially colorless, turns red and then blue when the hydrazine concentration is high. Absorbance monitoring at 540 nm allows hydrazine to be detected over a wide concentration range from 3.2 to 8096 μg·L⁻¹, with a detection limit of 2.72 μg·L⁻¹. Various teams have modified this method, replacing sulfamic acid with different stabilizers such as sodium dodecyl sulfate [¹⁹], dipicolinic acid [²⁰] or sodium citrate [²¹], in order to improve the sensitivity. The latter offers advantageous sensitivity, with a detection limit of 3.2×10⁻⁵ μg·L⁻¹ but a very limited measurement range extending only between 3.2×10⁻⁴ and 3.2 μg·L⁻¹.

The same principle was adopted by Tashkhourian et al. [²²] who propose the detection of hydrazine using the plasmon resonance of silver nanoparticles at 415 nm. Hydrazine reduces AgNO₃ to silver nanoparticles in the presence of stabilizers such as polyvinylpyrrolidone or dodecyldimethylammonium chloride. This method allows individual detection of hydrazine, phenylhydrazine and isoniazid, with detection limits of 3.84 μg·L⁻¹ (hydrazine), 13 μg·L^{31 1} (phenylhydrazine) and 16.4 μg·L⁻¹ (isoniazid) respectively, but is not selective.

Of all the methods listed for measuring hydrazine in water, only the p-dimethylaminobenzaldehyde (pDMAB) method is selective toward hydrazine and can be used at room temperature in the target hydrazine concentration range. The method is incidentally used industrially, but the protocol indicates a measuring time range of 16 h, after which the colored product, benzalazine, degrades. The use of this method with a 24 h delay in measurement is thus not possible. Moreover, this method does not allow the detection and quantification of interferents such as NH₂EtOH or morpholine, since the reaction products, if formed, would absorb in the UV in a range where the absorbance is saturated by that of pDMAB alone.

### Detection of Hydrazine in Air

Methods for measuring hydrazine in air are less numerous than those for the liquid phase, notably in the target range of 1.3 to 264 μg·m⁻³ (i.e. from 1 to 200 ppb). The current measurement method is described in INRS Data Sheet 21. It is based on the use of benzaldehyde [²³]. Hydrazine is collected by air suction through a tube filled with an inert adsorbent (Chromosorb P NAW or equivalent) of 3060 Mesh particle size, impregnated with sulfuric acid. The cartridge contents are desorbed with deionized water and benzaldehyde derivatization is performed. The adduct, benzalazine, is measured by liquid chromatography (HPLC) coupled with UV optical detection [^{24, 25}] This method allows 30 ppb of hydrazine to be detected within 15 minutes of sampling. A variant of this method is the use of a cassette containing two glass fiber filters impregnated with sulfuric acid. The hydrazine extraction is performed with an EDTA buffer solution and the derivatization is performed with benzaldehyde. The benzalazine formed is measured by liquid chromatography coupled with UV optical detection [²⁶]. This assay method proves to be sensitive, since it is possible to detect 0.017 ppb of N₂H₄. These two methods do not allow direct on-site measurement, and the interference of high concentrations of NH₃ or other amines, 50 to 100 times higher than that of hydrazine is not known.

Direct measurement methods are also available. In the context of monitoring worker exposure to hydrazine, monomethylhydrazine (MMH) and 1,1-dimethylhydrazine (UDMH) used as rocket fuels at air bases and space centers in the USA, several colorimetric dosimeters have been developed and sold by laboratories [^{27,28}]. The principle is based on the incorporation of an aromatic aldehyde such as vanillin, para-dimethylaminobenzaldehyde (pDMAB) or 2,4-dinitrobenzaldehyde on filter paper or an inert surface. Hydrazine and MMH react with vanillin or 2,4-dinitrobenzaldehyde to form a yellow-colored compound, while the product formed with pDMAB is orange. UDMH reacts with 2,4-dinitrobenzaldehyde to form a yellow-colored compound, and thus there is no reaction with vanillin and pDMAB. Colorimetric dosimeters based on vanillin and para-dimethylaminobenzaldehyde are sold by the company DODTEC [²⁹] and CHEMSEE [³⁰]. They enable estimation of the hydrazine and monomethylhydrazine contents in air in the range from 0.025 to 1.2 ppm.

In patent U.S. Ser. No. 00/571,9061 A [³¹], Rose-Pehrsson et al. propose a process allowing the selective detection and quantification of liquid or gaseous hydrazine, monomethylhydrazine and 1,1-dimethylhydrazine by derivatization with aromatic carboxyaldehydes and fluorimetric analysis. Selectivity is based on the reactivity of three derivatizing agents, ortho-phthalaldehyde (OPA), napthalene-2,3-dicarboxaldehyde (NDA) and anthracene-2,3-dicarboxaldehyde (ADA) with hydrazine, monomethylhydrazine and 1,1-dimethylhydrazine as a function of the pH of the reagent solution. These authors thus developed a complex device which allows ambient air to be pumped into and sparge a reagent solution whose composition (OPA or NDA or ADA) and pH must be modified to produce selectivity. Although the detection limit reached is of the ppb order, analysis of the gas mixture to be analyzed requires numerous reagent and pH change steps, followed by fluorimetric analysis. Moreover, there was no study of interference, notably with other amines at concentrations 50 to 100 times higher, which are liable to modify the pH of the solution.

For precise measurements, a number of commercial devices are available. The portable electrochemical detector from the company Interscan, model 4180-100b [³²] allows detection of hydrazine in a lower range from 0 to 100 ppb in less than 1 second, with a detection limit of 10 ppb. The method is, however, non-selective, since the sensor also detects NH₃, NOₓ, CO and other organic amines.

High sensitivity may also be obtained using devices equipped with a photoionization detector (PID), such as ppbRAE 3000 from the company RAE [³³]. The photoionization detector, equipped with a 10.6 eV lamp, allows hydrazine ionization and measurement of a few ppb in 3 seconds. Detection is not selective, however, as a large number of volatile organic compounds present in the air with ionization potentials below 10.6 eV are also detected, such as NH₃, ethanolamine and morpholine.

Hydrazine ionization followed by ion mobility measurement using an Ion Mobility Spectrometer (IMS) allows contents of about ten ppb (20-30 ppb) to be reached, while at the same time being selective in terms of the choice of carrier gas [38]. When using a radioactive source, the IMS (such as the SABRE 4000 [³⁴] or Environics ChemPro100i [³⁵] portable detector) must be under the responsibility of a person competent in radiation protection. This technique is favored by armies and police forces for the detection of chemical weapons and illicit products. Its application in the public domain has developed more recently with the development of new non-radioactive ionization sources (corona effect) such as the PAIMS portable detector from the company MaSaTECH [³⁶] or LCD 3.3 from Smiths Detection [³⁷].

The prior art in hydrazine measurement shows that the only simple method currently existing, using pDMAB as the reagent, can be used in the water compartment with good selectivity and sensitivity. However, the benzalanine formed in solution is unstable after 16 hours, and measurement cannot be performed after a delay of 24 hours. For the measurement of hydrazine in air, INRS (Institut National de Recherche et de Sécurité, for the prevention of work-related accidents and occupational illnesses) uses benzaldehyde. The method requires adsorption and then desorption steps prior to analysis, which are difficult to perform on site. Furthermore, for this method, interference with high concentrations of NH₃, ethanolamine or morpholine gas is not known, either in water or in air.

There is thus a real need for a hydrazine-selective process for detecting and, optionally, quantifying hydrazine that can be used in water and air compartments, which is compatible with the potential presence of high concentrations of interferents, which is readily performable on site and which enables measurement to be performed with a delay of up to at least 24 hours.

The process according to the invention addresses these issues.

### SUMMARY

A first subject of the invention is a process for detecting at least one amine-type compound, said compound being chosen from hydrazine, ethanolamine and morpholine, using a reagents composition comprising a mixture of 4-(dimethylamino)cinnamaldehyde and polystyrenesulfonic acid, said process comprising the steps of:
a) mixing said sample to be analyzed with said reagents composition to obtain a mixture consisting of the sample to be analyzed and said reagents composition,
b) detecting said amine-type compound(s) in the mixture consisting of the sample to be analyzed and said reagents composition.

Another subject of the invention is a reagents composition comprising a mixture of 4-(dimethylamino)cinnamaldehyde and polystyrenesulfonic acid.

A subject of the present invention is also the use of a reagents composition comprising a mixture of 4-(dimethylamino)cinnamaldehyde and polystyrenesulfonic acid for the detection of at least one amine-type compound, said compound being chosen from hydrazine, ethanolamine and morpholine.

Another subject of the invention is a kit for preparing the reagents composition according to the invention, said kit comprising:
a first container comprising 4-(dimethylamino)cinnamaldehyde;
a second container comprising an aqueous solution of polystyrenesulfonic acid.

### BRIEF DESCRIPTION OF THE DRAWINGS

Other features, details and advantages will appear on reading the detailed description below, and on analyzing the attached drawings, in which:

FIG. 1 shows the scheme for the reaction between N₂H₄ and two molecules of DMACA, with the formation of a colored product 2DMACA-N₂H₄ absorbing in the visible range.

FIG. 2 shows the differential spectra obtained at different times, showing the evolution of the 2DMACA-N₂H₄ complex toward its protonated form, with the presence of an isobestic absorbance point at 553 nm. The conditions applied being as follows: DMACA 5×10⁻³M+PSS 9.2 g·L⁻¹+N₂H₄ 5.5×10⁻⁶M, quartz cell with 1 cm optical path length.

FIG. 3 shows the scheme for the reaction between NH₂EtOH and DMACA, with formation of the NH₂EtOH-DMACA complex absorbing at 474 nm.

FIG. 4 shows the differential spectra for the reaction between DMACA and NH₂EtOH as a function of time. The conditions applied being as follows: DMACA 5×10⁻³M+PSS 9.2 g·L⁻¹+NH₂EtOH 6.24×10⁻⁴M, quartz cell with 1 cm optical path length.

FIG. 5 shows the scheme for the reaction between morpholine and DMACA, with formation of the morpholine-DMACA complex.

FIG. 6 shows the spectral evolution of the morpholine-DMACA complex as a function of time. The conditions applied being as follows: DMACA 5×10⁻³M+PSS 9.2 g·L⁻¹+morpholine 6.24×10⁻⁴ M, quartz cell with 1 cm optical path length.

FIG. 7 shows the calibration lines for the variation in absorbance of the 2DMACA-N₂H₄ adduct as a function of [N₂H₄] concentration between 5×10⁻⁷ and 5.5×10⁻⁶ M. The conditions applied are as follows: at 553 nm (5 min, isobestic point), at 474 nm at 24 h and at 487 nm at 1 h, [DMACA]=5×10⁻³ M, [PSS]=9.2 g·L⁻¹, i.e. r=[H⁺]/[DMACA]=10, 1 cm optical path length.

FIG. 8 shows the calibration line for the variation in absorbance at 24 h of the DMACA-NH₂EtOH adduct absorbing at 474 nm as a function of NH₂EtOH concentration between 1×10⁻⁴ and 2×10⁻³ M, at 24 h. The following conditions are applied: 1 cm optical path length. [DMACA]=5×10⁻³ M, [PSS]=9.2 g·L⁻¹, i.e. r=[H⁺]/[DMACA]=10.

FIG. 9 shows the calibration line for the variation in absorbance at 1 h of the DMACA-morpholine adduct absorbing at 487 nm as a function of morpholine concentration between 5×10⁻⁵ and 6.24×10⁻⁴ M at 1 h. The following conditions are applied: 1 cm optical path length. [DMACA]=5×10⁻³ M, [PSS]=9.2 g·L⁻¹, i.e. r=[H⁺]/[DMACA]=10.

FIG. 10 shows N₂H₄ measurements in the presence of interferents (NH₃+NH₂EtOH or NH₃+morpholine) on an industrial site and the comparison of the DMACA/PSS analytical method (with r=10) with the pDMAB (p-dimethylaminobenzaldehyde or pDMABA) analytical method and amperometric measurements.

FIG. 11 shows a repeatability test for measurements of low N₂H₄ contents. The conditions applied being as follows: 60 min of sampling at a flow rate of 1 L·min⁻¹ with sparging in 50 mL of a reagents solution (DMACA/PSS, r=10); with P=101325 Pa; R=8.3144621 J·K⁻¹·mol⁻¹; T=295 Kelvin.

### DETAILED DESCRIPTION

The subject of the present invention is a process for detecting in a sample to be analyzed at least one amine-type compound, said compound being chosen from hydrazine, ethanolamine, ammonia and morpholine, using a reagents composition comprising a mixture of 4-(dimethylamino)cinnamaldehyde and polystyrenesulfonic acid, said process comprising the steps of:
a) mixing said sample to be analyzed with said reagents composition to obtain a mixture consisting of the sample to be analyzed and said reagents composition,
b) detecting said amine-type compound(s) in the mixture consisting of the sample to be analyzed and said reagents composition.

In addition to detection, the process according to the invention may also allow determination in a sample to be analyzed of the concentration of at least one amine-type compound, said compound being chosen from hydrazine, ethanolamine and morpholine. Thus, according to a particular embodiment, the present invention relates to a process for detecting and quantifying in a sample to be analyzed at least one amine-type compound, said compound being chosen from hydrazine, ethanolamine and morpholine, using a reagents composition comprising a mixture of 4-(dimethylamino)cinnamaldehyde and polystyrenesulfonic acid, said process comprising the steps of:
a) mixing said sample to be analyzed with said reagents composition to obtain a mixture consisting of the sample to be analyzed and said reagents composition,
b) detecting and quantifying said amine-type compound(s) in the mixture consisting of the sample to be analyzed and said reagents composition.

Advantageously, the process according to the invention allows hydrazine detection, and also its quantification, despite the presence in the sample to be analyzed of interferents such as ammonia, ethanolamine or morpholine. The process according to the invention in this particular embodiment thus offers a real advantage, since it enables these amine-type compounds to be detected and quantified in a single step.

In the context of the present invention, the term “quantification” means determining the concentration of a compound within a sample to be analyzed.

The process according to the invention may advantageously be applied to a liquid or gaseous sample or an aerosol. The process according to the invention remains identical whether the sample to be analyzed is a liquid, a gas or an aerosol, only the method of collecting the sample to be analyzed may differ.

For the purposes of the present invention, the term “liquid sample” means a sample in the form of a solution or a suspension. For the purposes of the present invention, the term “aerosol” means a suspension, in air or in a gas, of solid or, more generally, liquid particles.

Step b) of detection or detection and quantification of the process according to the invention can be notably performed by measuring, as a function of time, the absorbance of the mixture consisting of the sample to be analyzed and said reagents composition. This step b) is thus performed in solution.

The advantages of the process according to the invention compared to those currently available, in particular that using the pDMAB reagent, are numerous:
It allows hydrazine (N₂H₄) to be detected and optionally quantified selectively, in particular via measurement of the absorbance as a function of time of the 2DMACA-N₂H₄ adduct, whose absorption spectrum in the visible range extends between 460 and 620 nm. Such detection and quantification are possible and remain reliable despite the presence of high interferent concentrations compared to the hydrazine concentration in the sample. The interferent concentrations may thus be more than 200 times higher than the hydrazine concentration, without impairing the efficacy of the hydrazine detection process.
In the case of a time-dependent absorbance measurement (also known as colorimetric measurement) of hydrazine in water, this is readily, rapidly and instantaneously achieved by collecting a specific volume of the solution to be analyzed and mixing it with the reagent solution.
In the case of measurement by absorbance as a function of time, by virtue of the existence of a stable isobestic absorbance point in the absorption spectrum of the 2DMACA-N₂H₄ adduct, hydrazine measurement via the absorbance of the addition complex at this point may be instantaneous or performed after a delay of up to 3 days, as the inventors have demonstrated that the isobestic point is stable for at least 3 days. The experimenter can thus have an instantaneous measurement of the hydrazine concentration, for example at 5 min, and 3 days, for example to check it later if he so wishes. The isobestic point corresponds to a wavelength at which the absorbance is constant during a chemical reaction. Thus, in the present case, the chemical reaction involves a starting material (here, 2DMACA-N₂H₄) and an end product (protonated 2DMACA-N₂H₄), which have the same absorption coefficient at this wavelength.
Measurement of hydrazine in air is performed using the same analytical method as when the sample is liquid, by collecting the air to be analyzed at constant speed and sparging it into the reagent solution for a specified period. Due to its high solubility, the N₂H₄ gas contained in the collected air is instantly dissolved in the reagent solution, and the N₂H₄ measurement is performed on the basis of the absorbance of the 2DMACA-N₂H₄ addition complex at the isobestic point.
This allows measurement of the concentrations of the interferents, ethanolamine (NH₂EtOH) or morpholine, in solution, notably by measuring the absorbance as a function of time of the adducts DMACA-NH₂EtOH or DMACA-morpholine, whose absorption spectra differ from that of 2DMACA-N₂H₄.
Quantification of ethanolamine or morpholine present in the air is also possible via their dissolution in the reagent solution and determination of the absorbance as a function of time of the colored DMACA-NH₂EtOH or DMACA-morpholine complexes.

The analytical method which allows the determination of the contents of hydrazine and of interferents bearing a primary or secondary amine function by measuring absorbance as a function of time requires knowledge of the absorption spectra of the reagent solution, of the 2DMACA-N₂H₄ addition complexes and of the DMACA addition complexes with the interferents ethanolamine (NH₂EtOH) and morpholine.

This method for measuring hydrazine in the presence of two interferents, NH₂EtOH+NH₃ or morpholine+NH₃, advantageously comprises the sequence of steps detailed hereinbelow.

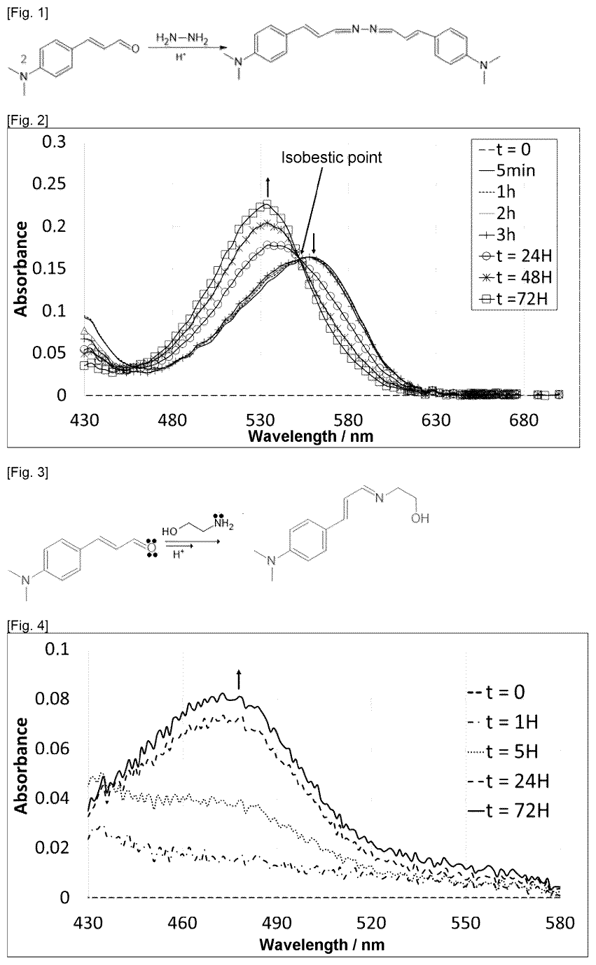

In aqueous solution, the reaction between hydrazine (N₂H₄) and 4-(dimethylamino)cinnamaldehyde (DMACA) catalyzed in the presence of polystyrenesulfonic acid gives rise to the formation of the red-colored 2DMACA-N₂H₄ addition complex ([FIG. 1] and [FIG. 2]).

The presence of polystyrenesulfonic acid is necessary to protonate DMACA and facilitate the addition of N₂H₄N₂H₄ to DMACA. However, N₂H₄ protonation may also take place in an acidic medium. This reaction would inhibit the formation of the 2DMACA-N₂H₄ addition complex. The amount of acid required for the reaction between N₂H₄ and DMACA must therefore be chosen to promote this reaction while at the same time minimizing N₂H₄ protonation.

The process according to the invention is thus advantageously performed with a ratio r of polystyrenesulfonic acid and 4-(dimethylamino)cinnamaldehyde concentrations ranging from 1 to 20, preferably from 2 to 15, even more preferentially 10.

This ratio is calculated from the molar concentrations of polystyrenesulfonic acid and 4-(dimethylamino)cinnamaldehyde (r=[H⁺]/[DMACA]). For this calculation, the molar mass of the polystyrenesulfonic acid monomer (M=184 g/mol) is used so as to convert the polystyrenesulfonic acid (PSS) mass concentration into a molar concentration. For example, a PSS concentration of 9.2 g·L⁻¹ corresponds to a concentration of 0.05 mol·L⁻¹ (=9.2/184). Thus, with a DMACA concentration of 5·10⁻³ mol·L⁻¹ and a PSS concentration of 9.2 g·L⁻¹ (0.05 mol·L⁻¹), the ratio r is equal to 10.

Tests performed with different amounts of PSS acid, 1.84-3.68-5.98 and 9.2 g·L⁻¹, i.e. with ratios r=[H⁺]/[DMACA] equal to 2-4-6.5 and 10, show, irrespective of the acidity of the medium, instantaneous formation of a product absorbing at 558 nm corresponding to the adduct, 2DMACA-N₂H₄. Moreover, there is an evolution of the product absorbing at 558 nm toward its protonated form absorbing at 535 nm, with the appearance of a stable isobestic point for 3 days. The wavelength corresponding to the isobestic point varies with the ratio r and thus ranges from 553 nm (r=10) to 538 nm (r=2).

The ratio of the concentrations of polystyrenesulfonic acid and 4-(dimethylamino)cinnamaldehyde may also be expressed as a ratio r′ of the mass concentrations of the two species (r′=[H⁺]/[DMACA]), this ratio r′ ranging from 1 to 20, preferably from 2 to 15, even more preferentially 11. For example, with a DMACA concentration of 5×10⁻³ mol·L⁻¹ corresponding to 0.876 g·L⁻¹ (with M=175.23 g·mol⁻¹) and a PSS concentration of 9.2 g·L⁻¹, the ratio r′ is equal to 10.5.

DMACA also reacts with other amines such as NH₂EtOH to give the NH₂EtOH-DMACA complex absorbing at 474 nm ([FIG. 3] and [FIG. 4]).

FIG. 4 shows the formation of the NH₂EtOH-DMACA complex and its evolution over time. The absorption maximum of the complex is at 474 nm, in a region where the 2DMACA-N₂H₄ complex and its protonated form practically do not absorb. The reaction between DMACA and NH₂EtOH is much slower than that between DMACA and N₂H₄. For the determination of the NH₂EtOH concentration, the time factor is taken into account for the calibration curve.

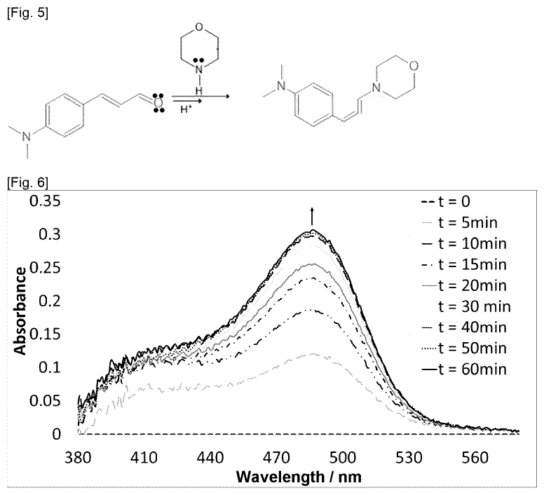

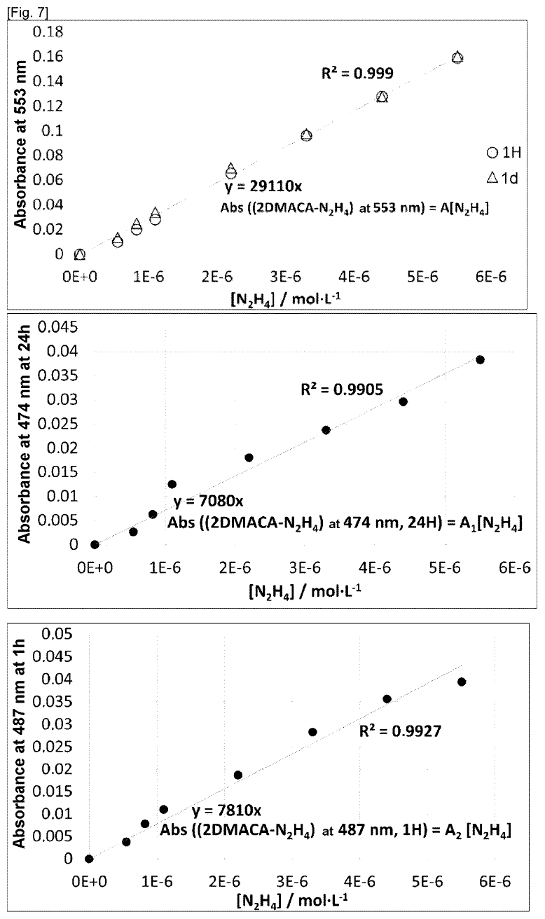

In the presence of morpholine, the morpholine-DMACA adduct is formed and absorbs at 487 nm (FIG. 5). The rate of formation of morpholine-DMACA is faster than that of ethanolamine-DMACA. Absorbance at 487 nm reaches a plateau after 1 h (FIG. 6).

According to a particular embodiment, the detection or detection and quantification process according to the invention can be performed according to the following steps:
1. Preparation of the reagents solution by mixing DMACA and PSS in water;
2. Establishment of N₂H₄ calibration curves from the absorbance of the 2DMACA-N₂H₄ addition complex at given wavelengths, for example at the isobestic point at 553 nm, at 487 nm (t=1 h) and at 474 nm (t=24 h);
3. Establishment of calibration curves for other amine-type compounds (interferents) at given wavelengths, for example 474 nm for ethanolamine and 487 nm for morpholine;
4. Preparation of the sample to be analyzed by mixing the reagents solution and the collected sample;
5. Measurement of the absorbance of the sample to be analyzed as a function of time (for example at 5 min, 1 h and 24 h);
6. Calculation of the concentrations of N₂H₄ and other amine-type compounds (interferents) from the spectra of absorbance as a function of time for the sample to be analyzed and the equations of the calibration curves previously obtained.

According to a particular embodiment, the process for detecting and quantifying N₂H₄ and NH₂EtOH (or morpholine) in water according to the invention can be performed by means of the following steps:

1. Preparing the Reagents Solution by Mixing Defined Amounts of DMACA and PSS in water.

A reagent stock solution is thus obtained with known final concentrations of DMACA and PSS and a similarly defined ratio r of these concentrations=[H⁺]/[DMACA].

2. Establishing N₂H₄ Calibration Curves from the Absorbance of the 2DMACA-N₂H₄ Addition Complex at the Isobestic Point at 553 nm, at 487 nm (t=1 h) and at 474 nm (t=24 h).

N₂H₄ calibration curves are produced by adding a volume x (for example 5 mL) of solution containing varying concentrations of N₂H₄, in the range from 5×10⁻⁷ to 5.5×10⁻⁶ mol·L⁻¹, to the same volume x of the reagents solution prepared in step 1. The solutions obtained are studied by UV-visible spectrophotometry between 5 min and 24 h using a quartz cell with a 1 cm optical path length.

Calibration curves are established at different wavelengths (FIG. 7): 553 nm (isobestic point), 474 nm (NH₂EtOH absorption peak) at 24 h and 487 nm (morpholine absorption peak) at 1 h. Plotting the lines corresponding to the temporal evolution of absorbance as a function of N₂H₄ concentration will afford, by linear regression, the following equations:

At the isobestic point, Abs((2DMACA-N₂H₄) at 553 nm)=A[N₂H₄]

At 474 nm and 24h, Abs((2DMACA-N₂H₄) at 474 nm,24h)=A₁[N₂H₄]

At 487 nm and at 1h, Abs((2DMACA-N₂H₄) at 487 nm,1h)=A₂[N₂H₄].

### 3. Establishing the Calibration Curve for the NH₂EtOH or Morpholine Interferent

3.a. Establishing the Calibration Curve for the NH₂EtOH Interferent from Absorbance Measurements of the DMACA-NH₂EtOH Complex at the Absorption Peak at 474 nm.

The NH₂EtOH calibration curve is produced by adding a volume x (for example 5 mL) of solution containing varying concentrations of NH₂EtOH, in the range 1×10⁻⁴ to 2×10⁻³ mol·L⁻¹, to the same volume x of the reagents solution prepared in step 1.

The calibration curve of the DMACA-NH₂EtOH adduct is produced by measuring the absorbance at 474 nm, at 24 h with a quartz cell of 1 cm optical path length. Plotting the line corresponding to the evolution of absorbance at 24 h as a function of NH₂EtOH concentration will afford, by linear regression, the following equation:

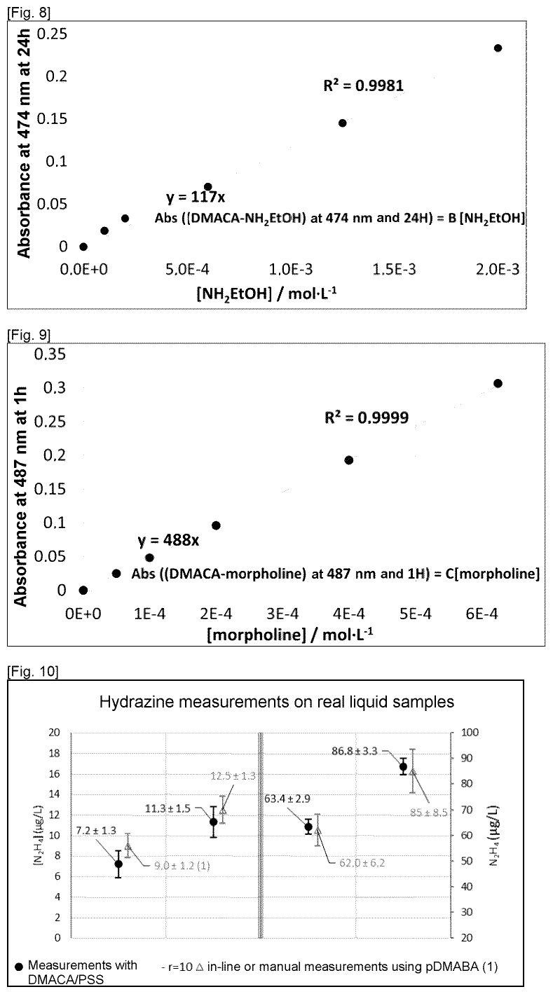

Abs((DMACA-NH₂EtOH) at 474 nm and 24h)=B[NH₂EtOH] (FIG. 8).

3.b. Establishment of the Calibration Curve for the Morpholine Interferent from the Absorbance Measurement of the DMACA-Morpholine Complex at the Absorption Peak at 487 nm.

The morpholine calibration curve is produced by adding a volume x (for example 5 mL) of solution containing varying concentrations of morpholine, in the range from 5×10⁻⁵ to 6.24×10⁻⁴ mol·L⁻¹, to the same volume x of the reagents solution prepared in step 1.

The calibration curve of the DMACA-morpholine adduct is produced by measuring the absorbance at 487 nm, at 1 h with a quartz cell of 1 cm optical path length. Plotting the line corresponding to the evolution of absorbance at 1 h as a function of morpholine concentration will afford, by linear regression, the following equation:

Abs((DMACA-morpholine) at 487 nm and 1h)=C[morpholine] (FIG. 9).

### 4. Sampling

The collection of the sample to be analyzed, containing N₂H₄ and NH₂EtOH (or N₂H₄ and morpholine), is performed as follows:
In a volumetric flask, a volume x (for example 5 mL) of the reagents solution is introduced, followed by the same volume x of sample to be analyzed. The actual concentrations of the analytes having thus been diluted twofold in this mixture, whose absorbance will be measured, it is necessary to take account of this dilution by a coefficient 2 when calculating the concentrations.
The absorption spectrum of the mixture composed of the reagents solution and the sample to be analyzed is collected between 400 and 700 nm at 5 min and at 24 h when the interferent is NH₂EtOH.
The absorption spectrum of the mixture composed of the reagents solution and the sample to be analyzed is collected between 400 and 700 nm at 5 min and at 1 h when the interferent is morpholine.

### 5. Calculations

5.a. Calculation of the N₂H₄ Concentration in the Mixture Containing N₂H₄ and NH2₂EtOH (or Morpholine) is as Follows:

The absorbance (Abs) of the 2DMACA-N₂H₄ adduct is measured at the isobestic point of 2DMACA-N₂H₄ and protonated 2DMACA-N₂H₄, at 553 nm when r=10.

The N₂H₄ concentration of the sample in mol·L⁻¹ is deduced using the calibration curve previously produced at the isobestic point Abs ((2DMACA-N₂H₄) at 553 nm)=A [N₂H₄], according to the equation:

$$[ {N}_{2} {H}_{4} ] = \frac{Abs ( ( 2 DMA CA - N2H4 ) at 553 nm )}{A} 2$$

5.b. When the Interferent is NH₂EtOH, the Calculation of the NH₂EtOH Concentration in the Mixture Containing N₂H₄ and NH₂EtOH is as Follows:

From the N₂H₄ concentration obtained in 5.a., the absorbance of 2DMACA-N₂H₄ at 474 nm and 24 h is obtained from the calibration curve Abs ((2DMACA-N₂H₄) at 474 nm, 24 h)=A1 [N₂H₄], obtained in 2.

The absorbance of DMACA-NHN₂H₄EtOH in the mixture at 24 h is deduced:

Abs((DMACA-NHN₂H₄EtOH) at 474 nm)=Abs((mixture) at 474 nm)−Abs((2DMACA-N₂H₄) at 474 nm)

The NH₂EtOH concentration in mol·L⁻¹ of the sample is deduced from the calibration curve Abs (DMACA-NH₂EtOH)=B [NH₂EtOH] obtained in 3.a. (FIG. 8):

$$[ {NH}_{2} Et OH ] = 2 \frac{Abs ( ( DMACA - {NH}_{2} Et OH ) at 474 nm )}{B}$$

5.c. When the Interferent is Morpholine, the Calculation of the Morpholine Concentration in the Mixture Containing N₂H₄ and Morpholine is as Follows:

From the N₂H₄ concentration obtained in 5.a., the absorbance of 2DMACA-N₂H₄ at 487 nm at 1 h is obtained from the calibration curve Abs ((2DMACA-N₂H₄) at 487 nm, 1 h)=A₂ [N₂H₄], obtained in 2. (FIG. 7).

The absorbance of DMACA-morpholine in the mixture at 1 h is deduced:

Abs((DMACA-morpholine) at 487 nm)=Abs((mixture) at 487 nm)−Abs((2DMACA-N₂H₄) at 487 nm,1h)

The morpholine concentration in mol·L⁻¹ of the sample is deduced from the calibration curve Abs (DMACA-morpholine)=C [morpholine] obtained in 3.b. (FIG. 9):

$$[ morpholine ] = 2 \frac{( Abs ) at 487 nm}{C}$$

According to another particular embodiment, when the sample to be analyzed is a gaseous sample, the steps of the process for detecting and quantifying N₂H₄ and NH₂EtOH (or morpholine) according to the invention may be identical to those described above for a liquid sample to be analyzed. Nevertheless, the process for detecting and quantifying gaseous N₂H₄ and NH₂EtOH (or morpholine) requires an additional step compared with the same process applied to a sample in aqueous solution. This additional step corresponds to collecting the ambient air to be analyzed and sparging it into the mixture of liquid reagents.

The sampling step may thus be performed as follows: the air to be analyzed is pumped at a known flow rate (e.g. 1 L·min⁻¹) through a bubbler filled with a known volume (for example 50 mL) of the mixture of reagents DMACA and PSS. After one hour, the solution is collected for spectrophotometric analysis.

The spectrum of the mixture is then collected between 400 and 700 nm at 5 min and after 24 h when the interferent is NH₂EtOH. The spectrum of the mixture is collected between 400 and 700 nm at 5 min and after 1 h when the interferent is morpholine.

A subsequent calculation step enables determination of the concentrations of N₂H₄ and NH₂EtOH (or morpholine) dissolved in the reagent. To find the concentrations of these analytes in the gas mixture, the total volume of gas pumped (for example, at a stream of 1 L·min⁻¹) for 1 hour must be taken into account.

5′.a. Calculation of the Concentration of N₂H₄ in the Mixture Containing N₂H₄ and NH₂EtOH (or Morpholine) is Calculated as Follows:

The absorbance (Abs) of the 2DMACA-N₂H₄ adduct is measured at the isobestic point of the 2DMACA-N₂H₄ and protonated 2DMACA-N₂H₄ complexes, at 553 nm when r=10.

The N₂H₄ concentration of the sample in mol·L⁻¹ is deduced using the calibration curve previously produced at the isobestic point Abs ((2DMACA-N₂H₄) at 553 nm)=A [N₂H₄], according to the equation:

$$[ {N}_{2} {H}_{4} ] = \frac{Abs ( ( 2 DMA CA - N2H4 ) at 553 nm )}{A}$$

5′.b. Calculation of the NH₂EtOH Concentration in the Mixture Containing N₂H₄ and NH₂EtOH is as Follows:

From the N₂H₄ concentration obtained in 5′.a., the absorbance of 2DMACA-N₂H₄ at 474 nm and 24 h is obtained from the calibration curve Abs ((2DMACA-N₂H₄) at 474 nm, 1 h)=A₁ [N₂H₄], obtained in 2.

The absorbance of DMACA-NH₂EtOH in the mixture at 24 h is deduced from:

Abs((DMACA-NH₂EtOH) at 474 nm)=Abs((mixture) at 474 nm)−Abs((2DMACA-N₂H₄) at 474 nm)

The NH₂EtOH concentration in mol·L⁻¹ of the sample is deduced from the calibration curve Abs((DMACA-NH₂EtOH) at 474 nm)=B [NH₂EtOH] obtained in 3.a.:

$$[ {NH}_{2} EtOH ] = \frac{Abs ( DMACA - N {H}_{2} EtOH ) at 474 nm}{B}$$

5′.c. When the Interferent is Morpholine, the Calculation of the Morpholine Concentration in the Mixture Containing N₂H₄ and NH₂EtOH is as Follows:

From the N₂H₄ concentration obtained in 5′.a., the absorbance of 2DMACA-N₂H₄ at 487 nm at 1 h is obtained from the calibration curve Abs ((2DMACA-N₂H₄) at 487 nm)=A₂ [N₂H₄], obtained in 2.

The absorbance of DMACA-morpholine in the mixture at 1 h is deduced:

Abs((DMACA-morpholine) at 487 nm)=Abs((mixture) at 487 nm)−Abs((2DMACA-N₂H₄) at 487 nm)

The morpholine concentration in mol·L⁻¹ of the sample, is deduced from the calibration curve Abs(DMACA-morpholine) at 487 nm)=C [morpholine] obtained in 3.b.

$$[ morpholine ] = \frac{Abs ( DMACA - morpholine ) at 487 nm )}{C}$$

5′.d. The N₂H₄ (or NH₂EtOH or Morpholine) Content in the Gas Mixture in Ppb is Deduced According to the Equation:

$$[ i ] ( ppb ) = \frac{number of moles of i}{number of moles of air} * {10}^{9}$$

with:
i i=N₂H₄, NH₂EtOH or morpholine
number of moles of i=[i](mol·L⁻¹)*V (V=volume of reagent solution=for example 50×10⁻³ L)

$$[ number of moles of air ] = \frac{D * 𝔱}{{V}_{m}}$$

(D=air flow rate=for example 1 L·min⁻¹, t=sampling time=1 h, Vₘ=air molar volume=24.21 L·mol⁻¹ at 22° C.)

In addition to the detection method as defined previously, a subject of the present invention is also a reagents composition comprising a mixture of 4-(dimethylamino)cinnamaldehyde and polystyrenesulfonic acid. In a medium comprising an amine-type compound, for example hydrazine, ethanolamine or morpholine, this composition advantageously enables the reaction between the amine-type compound and 4-(dimethylamino)cinnamaldehyde, this reaction being catalyzed with polystyrenesulfonic acid and giving rise to the formation of an addition complex having absorbance properties in the UV-visible range.

The reaction between the amine-type compound and 4-(dimethylamino)cinnamaldehyde (DMACA) is advantageously catalyzed by an acid derived from a polymer, in particular polystyrenesulfonic acid. The choice of this type of acid, and in particular polystyrenesulfonic acid, has many advantages. Firstly, this acid is a high molecular weight polymer including an SO₃H acid function for each styrene monomer. As a result, the number of available protons is particularly high, allowing the acidity of the solution to be adjusted to catalyze the reaction between DMACA and N₂H₄.

Moreover, inorganic acids and organic acids of low molecular weight have the drawback that acid vapors may be released during the step of sparging the gaseous mixture to be analyzed, the acid then being liable to evaporate off during the sparging. This drawback is not present for acids derived from a polymer, such as polystyrenesulfonic acid, as these acids are not volatile.

One of the major advantages of this reagents composition is its stability over time, which may be up to at least one week. This stability was demonstrated by the inventors by measuring the absorbance spectrum of the reagents composition up to one week after its preparation. The spectrum obtained was identical to that obtained directly after preparation of the composition. The composition may thus be prepared and stored for this length of time without impairing its efficacy in the process according to the invention. This feature advantageously removes the constraint of having to prepare the reagents composition prior to each sample analysis process.

According to a particular embodiment, the composition according to the invention is characterized by a particular ratio r of the concentrations of 4-(dimethylamino)cinnamaldehyde and polystyrenesulfonic acid, this ratio ranging from 1 to 20, preferably from 2 to 15, even more preferentially 10.

A subject of the present invention is also the use of a reagents composition according to the invention for detecting at least one amine-type compound, said compound being chosen from hydrazine, ethanolamine and morpholine.

According to a particular embodiment, the invention also relates to the use of a reagents composition according to the invention for the quantification of at least one amine-type compound, said compound being chosen from hydrazine, ethanolamine and morpholine.

The use according to the invention may advantageously be applied on a liquid or gaseous sample or an aerosol.

Another subject of the present invention is a kit for preparing a reagents composition according to the invention, said kit comprising:
a first container comprising 4-(dimethylamino)cinnamaldehyde;
a second container comprising an aqueous solution of polystyrenesulfonic acid.
   The kit according to the invention advantageously allows the reagents composition according to the invention to be prepared for its use in the process according to the invention. This preparation is particularly simple and quick to perform, since it only requires the mixing of two compounds in water.

### EXAMPLES

### Compounds Used

4-(Dimethylamino)cinnamaldehyde (DMACA, Sigma-Aldrich, Ref: D4506-5 g, batch: BCBX0916, CAS: 6203-18-5, purity÷98%, molar mass=175.23 g/mol),
Polystyrenesulfonic acid at 18% in water (PSS, Sigma-Aldrich, Ref: 561223-100 G, batch: MKBV7207V, CAS: 28210-41-5, molar mass˜75 000 g/mol, density=1.11 g/mL at 25° C.),
Hydrazine hydrate at 50-60% in water (N₂H₄, Sigma-Aldrich, Ref: 225819-100 mL, batch: BCCC1556, CAS: 10217-52-4, molar mass=32.05 g/mol, density=1.029 g/mL at 25° C.),
Ethanolamine (NH₂EtOH, Sigma-Aldrich, Ref: 398136-500 mL, batch: STBJ4500, CAS: 141-43-5, purity≥98%, molar mass=61.08 g/mol, density=1.012 g/mL at 25° C.),
Morpholine (Sigma-Aldrich, Ref: 252360-100 mL, batch: MCKM6935, CAS: 110-91-8, purity≥99%, molar mass=87.012 g/mol, density=0.996 g/mL at 25° C.),
Aqueous 28% ammonia solution (NH₃, VWR, Ref: 21182.94, batch: 15J260522, CAS: 1336-21-6, molar mass=17.03 g/mol, density d=0.89 g/mL),
Milli-Q® deionized water.

### Example 1: Protocol for Assaying N₂H₄ and NH₂EtOH (or Morpholine) in Aqueous Solutions with the Reagents Solution Containing [DMACA]=5×10⁻³ M, [PSS]=9.2 g·L⁻¹, i.e. r=[H⁺]/[DMACA]=10

The assay of N₂H₄ and NH₂EtOH (or morpholine) in water is performed as follows:

1) Preparation of the reagents solution: 87.62 mg of DMACA and 4.604 mL of 18% PSS are placed in a 50 mL volumetric flask containing 25 mL of water. Water is added up to the graduation mark, and the solution is then sonicated in an ultrasonic bath for 30 minutes to fully dissolve the DMACA. A reagents stock solution is obtained with final DMACA and PSS concentrations of 0.01 M and 18.4 g·L⁻¹, respectively. The ratio r=[H⁺]/[DMACA=10.

2) Establishment of N₂H₄ calibration curves from the absorbance of the 2DMACA-N₂H₄ addition complex at the isobestic point at 553 nm, 487 nm (t=1 h) and 474 nm (t=24 h), for r=[H⁺]/[DMACA]=10)
a) The N₂H₄ calibration curves are produced by adding 5 mL of solution containing varying concentrations of N₂H₄, in the range 5×10⁻⁷ to 5.5×10⁻⁶ mol·L⁻¹, to 5 mL of reagents solution prepared in step 1). The solutions are studied by UV-visible spectrophotometry between 5 min and 24 h using a quartz cell with a 1 cm optical path length. The calibration curves are established at different wavelengths ([FIG. 7]): 553 nm (isobestic point), 474 nm (NH₂EtOH absorption peak) at 24 h and 487 nm (morpholine absorption peak) at 1 h:
   At the isobestic point, Abs (553 nm)=Ax=29110 [N₂H₄].
   At 474 nm and 24 h, Abs (474 nm, 24 h)=A₁x=7080 [N₂H₄]
   At 487 nm and 1 h, Abs (487 nm, 1 h)=A₂x=7810 [N₂H₄].

3) Establishment of the calibration curve for NH₂EtOH or morpholine interferent
a) Establishment of the calibration curve for the NH₂EtOH interferent from absorbance measurements of the DMACA-NH₂EtOH complex at the absorption peak at 474 nm at 24 h.

The calibration curve for NH₂EtOH is produced by adding 5 mL of solution containing varying concentrations of NH₂EtOH, in the range 1×10⁻⁴ to 2×10⁻³ mol·L⁻¹, to 5 mL of the reagents solution prepared in step 1). The calibration curve of the DMACA-NH₂EtOH adduct is produced by measuring the absorbance at 474 nm, at 24 h with a quartz cell with a 1 cm optical path length.

Abs (DMACA-NH₂EtOH) at 474 nm and 24 h=Bx=117 [NH₂EtOH]([FIG. 8]).
b) Calibration curve for the morpholine interferent based on absorbance measurements of the DMACA-morpholine complex at the absorption peak at 487 nm.

The morpholine calibration curve is produced by adding 5 mL of solution containing varying concentrations of morpholine, in the range from 5×10⁻⁵ to 6.24×10⁻⁴ mol·L⁻¹, to 5 mL of the reagents solution prepared in step 1). The calibration curve for the DMACA-morpholine adduct is produced by measuring the absorbance at 487 nm, at 1 h with a quartz cell with a 1 cm optical path length.

Abs (DMACA-morpholine) at 487 nm and 1 h=Cx=488 [morpholine](FIG. 9).

4) Sampling

The solution to be analyzed, containing N₂H₄ and NH₂EtOH (or N₂H₄ and morpholine), is collected as follows:
5 mL of the reagents solution are introduced into a 10 mL volumetric flask, followed by 5 mL of the sample to be analyzed. Since the actual concentrations of the analytes have been diluted twofold in the mixture, this dilution must be taken into account when calculating the concentrations.
the absorption spectrum of the mixture is collected between 400 and 700 nm at 5 min and at 24 h when the interferent is NH₂EtOH.
the absorption spectrum of the mixture is collected between 400 and 700 nm at 5 min and at 1 h when the interferent is morpholine.

5) Calculations
a) The concentration of N₂H₄ in the mixture containing N₂H₄ and NH₂EtOH (or morpholine) is calculated as follows:
   Absorbance (Abs) of the 2DMACA-N₂H₄ adduct at the isobestic point, 553 nm.
   The N₂H₄ concentration of the sample in mol·L⁻¹ is deduced using the calibration curve previously produced at the isobestic point Abs (553 nm)=Ax=29110 [N₂H₄], according to the equation:

$$[ {N}_{2} {H}_{4} ] = \frac{Abs ( 553 nm )}{29110} 2$$

b) When the interferent is NH₂EtOH, the calculation of the NH₂EtOH concentration in the mixture containing N₂H₄ and NH₂EtOH is as follows:
   From the N₂H₄ concentration obtained in 5)a), the absorbance of 2DMACA-N₂H₄ at 474 nm and at 24 h is obtained from the calibration curve Abs (2DMACA-N₂H₄) at 474 nm, 24 h=7080 [N₂H₄], obtained in 2)a).
   The absorbance of DMACA-NH₂EtOH in the mixture at 24 h is deduced:

Abs(DMACA-NH₂EtOH) at 474 nm=Abs(mixture) at 474 nm−Abs(2DMACA-N₂H₄) at 474 nm
The NH₂EtOH concentration in mol·L⁻¹ of the sample is deduced from the calibration curve Abs(DMACA-NH₂EtOH)=117 [NH₂EtOH] obtained in 3)a) (FIG. 8):

$$[ N {H}_{2} EtOH ] = 2 \frac{Abs ( DMACA - N {H}_{2} EtOH ) at 474 nm}{117}$$

c) When the interferent is morpholine, the calculation of the morpholine concentration in the mixture containing N₂H₄ and morpholine is as follows:
   From the N₂H₄ concentration obtained in 5)a), the absorbance of 2DMACA-N₂H₄ at 487 nm at 1 h is obtained from the calibration curve Abs (2DMACA-N₂H₄) at 487 nm, 1 h=7810 [N₂H₄], obtained in 2)a) (FIG. 7).
   The absorbance of DMACA-morpholine in the mixture at 1 h is deduced:

Abs(DMACA-morpholine) at 487 nm=Abs(mixture) at 487 nm−Abs(2DMACA-N₂H₄) at 487 nm
The morpholine concentration in mol·L⁻¹ of the sample, using the calibration curve Abs(DMACA-morpholine)=488 [morpholine] obtained in 3)b) (FIG. 9):

$$[ morpholine ] = 2 \frac{( Abs ) a t 487 nm}{488}$$

### Example 2: Protocol for Assaying N₂H₄ and NH₂EtOH in Aqueous Solutions with the Reagents Solution Containing [DMACA]=5×10⁻³ M, [PSS]=3.68 g·L⁻¹, i.e. r=[H⁺]/[DMACA]=4

The protocol is the same as described previously in Example 1 for the reagents solution containing DMACA and PSS, where r=[H⁺]/[DMACA]=10.

N₂H₄ calibration curves are established with a reagents solution containing [DMACA]=5×10⁻³ M, [PSS]=3.68 g·L⁻¹, where r=[H⁺]/[DMACA]=4, at different wavelengths: 542 nm (isobestic point) and 474 nm (absorption peak of NH₂EtOH):
At the isobestic point (at 542 nm), Abs (542 nm)=Ax=37744 [N₂H₄].
At 474 nm and 24 h, Abs (474 nm, 24 h)=A₁x=9599 [N₂H₄].

The calibration curve for the DMACA-NH₂EtOH adduct is established at 474 nm, at 24 h:

Abs (DMACA-NH₂EtOH) at 474 nm and 24 h=Bx=429 [NH₂EtOH]

### Example 3: Protocol for Assaying N₂H₄ and NH₂EtOH (or Morpholine) in the Gaseous State with the Reagents Solution Containing [DMACA]=5×10⁻³ M, [PSS]=9.2 g·L⁻¹, i.e. r=[H⁺]/[DMACA]=10

For the measurement of gaseous analytes, gaseous N₂H₄ and NH₂EtOH and morpholine must be generated and their concentrations calibrated.

The protocol for assaying gaseous N₂H₄ and NH₂EtOH (or morpholine) requires an additional step compared with assaying these same analytes in aqueous solution. This step corresponds to collecting the ambient air to be analyzed and sparging it into the liquid reagent.

The protocol is the same as that described in Example 1 for the quantification of analytes in aqueous solution for steps 1), 2) 3).

Sampling step 4) is as follows: the air to be analyzed is pumped at a flow rate of 1 L·min⁻¹ through a 3.16 cm diameter, 34 cm high bubbler filled with 50 mL of the reagents solution prepared in step 1). After one hour, the solution is collected for spectrophotometric analysis.

The spectrum of the mixture is collected between 400 and 700 nm at 5 min and after 24 h when the interferent is NH₂EtOH.

The spectrum of the mixture is collected between 400 and 700 nm at 5 min and after 1 h when the interferent is morpholine.

Step 5) of the calculations enables determination of the concentrations of N₂H₄ and NH₂EtOH (or morpholine) dissolved in the reagent. To find the concentrations of these analytes in the gas mixture, the total volume of gas pumped at a flow rate of 1 L·min⁻¹ for 1 h must be taken into account.
a) Calculation of the N₂H₄ concentration in the mixture containing N₂H₄ and NH₂EtOH (or morpholine) is as follows:
   The absorbance (Abs) of the 2DMACA-N₂H₄ adduct at the isobestic point, 553 nm for r=[H⁺]/[DMACA]=10.
   The N₂H₄ concentration of the sample in mol·L⁻¹ is deduced using the calibration curve previously produced at the isobestic point Abs (553 nm)=Ax=29110 [N₂H₄], according to the equation:

$$[ {N}_{2} {H}_{4} ] = \frac{Abs ( 553 nm )}{29110}$$

b) Calculation of the NH₂EtOH concentration in the mixture containing N₂H₄ and NH₂EtOH is as follows:
   From the N₂H₄ concentration obtained in 5)a), the absorbance of 2DMACA-N₂H₄ at 474 nm and at 24 h is obtained from the calibration curve Abs (2DMACA-N₂H₄) at 474 nm, 1 h=7080 [N₂H₄], obtained in 2)a) (FIG. 9).
   The absorbance of DMACA-NH₂EtOH in the mixture at 24 h is deduced from:

Abs(DMACA-NH₂EtOH) at 474 nm=Abs(mixture) at 474 nm−Abs((2DMACA-N₂H₄) at 474 nm
The NH₂EtOH concentration in mol·L⁻¹ of the sample is deduced from the calibration curve Abs(DMACA-NH₂EtOH)=117 [NH₂EtOH] obtained in 3)a):

$$[ N {H}_{2} EtOH ] = \frac{Abs ( DMACA - N {H}_{2} EtOH ) at 474 nm}{117}$$

c) When the interferent is morpholine, calculation of the morpholine concentration in the mixture containing N₂H₄ and NH₂EtOH is as follows:
   From the N₂H₄ concentration obtained in 5)a), the absorbance of 2DMACA-N₂H₄ at 487 nm at 1 h is obtained from the calibration curve Abs (2DMACA-N₂H₄) at 487 nm, 1 h=7810 [N₂H₄], obtained in 2)a) (FIG. 9).
   The absorbance of DMACA-morpholine in the mixture at 1 h is deduced:

Abs(DMACA-morpholine) at 487 nm=Abs(mixture) at 487 nm−Abs((2DMACA-N₂H₄) at 487 nm
The morpholine concentration in mol·L⁻¹ of the sample, using the calibration curve Abs(DMACA-morpholine)=488 [morpholine] obtained in 3)b) (FIG. 11):

$$[ morpholine ] = \frac{( Abs ) at 487 nm}{488}$$

d) The N₂H₄ (or NH₂EtOH or morpholine) content in the gas mixture in ppb is deduced according to the equation:

$$[ i ] ( ppb ) = \frac{n umber of moles of i}{n umber of moles of air} * {10}^{9}$$

with:
   i=N₂H₄, NH₂EtOH, or morpholine
   number of moles of i=[i](mol·L⁻¹)*V (V=volume of reagent solution=50×10⁻³ L)

$$[ number of moles of air ] = \frac{D * 𝔱}{{V}_{m}}$$

(D=air flow rate=1 L·min⁻¹, t=sampling time=1 h, Vₘ=molar volume=24.21 L·mol⁻¹ at 22° C.)

### Example 4: Application of the Process According to the Invention to the Determination of N₂H₄ and NH₂EtOH in Aqueous Solutions Containing Different Analyte Concentrations and in the Presence of a Strong Base, NH₃ with 50 [N₂H₄]<[NH₃]<100 [N₂H₄]. Reagents Solution: [DMACA]=5×10⁻³ M, [PSS]=9.2 g·L⁻¹, i.e. r=[H⁺]/[DMACA]=10 and the Isobestic Point at 553 nm

Seven examples of application of the method are given here. Mixtures of known concentrations of N₂H₄, NH₂EtOH and NH₃ with different ratios of [NH₃]/[N₂H₄] and [NH₂EtOH]/[N₂H₄] were prepared and the spectra of the mixtures were collected at 24 h. These spectra were analyzed by collecting absorbance values at the specific wavelengths, 553 and 474 nm, to deduce the concentrations of N₂H₄ and NH₂EtOH. The calculated values were then compared with the theoretical concentration values (Table 1).

TABLE 1

| | | | | [N₂H₄] × 10⁻⁶M | | | | | |
|---|---|---|---|---|---|---|---|---|---|
| | | | | Calcul- | | | [NH₂EtOH] × 10⁻⁴M | | |
| | | | | ation | | | Calcula- | | Devia- |
| | $\frac{[ {NH}_{3} ]}{[ {N}_{2} {H}_{4} ]}$ | $\frac{[ {NH}_{2} Et OH ]}{[ {N}_{2} {H}_{4} ]}$ | [NH₃] × 10⁻⁴M Theoretical | (Δ = ±7%) | Theo- retical | Devia- tion (%) | tion (Δ = ±7%) | Theo- retical | tion (%) |
| Ex. 1 | 100 | 100 | 5.63 | 5.83 | 5.63 | +3.5 | 6.42 | 5.63 | +14.1 |
| Ex. 2 | 100 | 100 | 4.50 | 4.49 | 4.5 | +0.3 | 5.16 | 4.50 | +14.7 |
| Ex. 3 | 100 | 100 | 3.38 | 3.27 | 3.38 | +3.1 | 2.65 | 3.38 | −21.5 |
| Ex. 4 | 100 | 100 | 2.25 | 2.16 | 2.25 | +4.2 | 1.64 | 2.25 | −27.1 |
| Ex. 5 | 100 | 50 | 4.5 | 4.31 | 4.19 | +2.7 | 2.90 | 2.25 | +28.8 |
| Ex. 6 | 50 | 60 | 1.75 | 3.37 | 3.26 | +3.4 | 2.68 | 2.10 | +27.5 |
| Ex. 7 | 10 | 80 | 0.15 | 1.48 | 1.4 | +5.8 | 0.97 | 1.20 | −19.2 |

Table 1: Assay results for N₂H₄ and NH₂EtOH in the mixture containing NH₃, N₂H₄ and NH₂EtOH.
[DMACA] = 5 × 10⁻³M, [PSS] = 9.2 g.L⁻¹, i.e. r = [H⁺]/[DMACA] = 10, 1 cm optical path length.
Deviation = (calculated value − theoretical value)/theoretical value.

This example demonstrates the very good reliability of the process according to the invention, in particular as regards the detection and quantification of hydrazine, since very small deviations (less than 6%) are observed between the calculated and theoretical values.

This example also demonstrates the very good sensitivity of the process as regards the detection and quantification of hydrazine, since the concentrations calculated via the process are very close to the theoretical concentrations despite concentrations of interferents (NH₃ or NH₂EtOH) up to 100 times greater than that of hydrazine.

### Example 5: Application of the Process According to the Invention to the Determination of N₂H₄ and Morpholine in Aqueous Solutions Containing Different Analyte Concentrations and in the Presence of a Strong Base, NH₃ with [NH₃]=150 [N₂H₄]. Reagents Solution: [DMACA]=5×10⁻³ M, [PSS]=9.2 g·L⁻¹, i.e. r=[H⁺]/[DMACA]=10 and the Isobestic Point at 553 nm

Four examples of application of the analytical method are given here. Mixtures of known concentrations of N₂H₄, morpholine and NH₃ with ratios of [NH₃]/[N₂H₄]=100 and [morpholine]/[N₂H₄]=100 were prepared and the spectra of the mixtures were collected at 1 h. These spectra were analyzed by collecting absorbance values at specific wavelengths, 553 and 487 nm, to deduce the N₂H₄ and morpholine concentrations. The calculated values are then compared with theoretical concentration values (Table 2).

TABLE 2
Assay results for N₂H₄ and morpholine in the mixture
containing NH₃, N₂H₄ and morpholine. [NH₃] =
[morpholine] = 100 × [N₂H₄], [DMACA] = 5 × 10⁻³M,
[PSS] = 9.2 g · L⁻¹, 1 cm optical path length.
Deviation = (calculated value − theoretical
value)/theoretical value.

| | [NH₃] (×10⁻⁴M) | [N₂H₄] (×10⁻⁶M) | | | [morpholine] (×10⁻⁴M) | | |
|---|---|---|---|---|---|---|---|
| | Theoretical | 4.83 | 4.66 | −3.8 | 4.36 | 4.66 | +6.5 |
| Ex. 1 | 4.66 | 3.24 | 3.26 | +0.3 | 2.92 | 3.26 | +10.4 |
| Ex. 2 | 3.26 | 1.98 | 1.86 | −6.6 | 1.85 | 1.86 | +0.3 |
| Ex. 3 | 1.86 | 0.95 | 0.932 | −2.1 | 0.934 | 0.932 | −0.2 |
| Ex. 4 | 0.466 | 4.83 | 4.66 | −3.8 | 4.36 | 4.66 | +6.5 |

As with Example 1, this example demonstrates the very good reliability of the process according to the invention, in particular as regards the detection and quantification of hydrazine, since very small deviations (less than 7%) are observed between the calculated and theoretical values.

This example also demonstrates the very good sensitivity of the process as regards the detection and quantification of hydrazine, since the concentrations calculated via the process are very close to the theoretical concentrations despite concentrations of interferents (NH₃ and morpholine) 100 times greater than that of hydrazine.

### Example 6: Application of the Process According to the Invention to the Determination of N₂H₄ and NH₂EtOH in Aqueous Solutions Containing Different Analyte Concentrations and in the Presence of a Strong Base, NH₃ with [NH₃]═[NH₂EtOH]=96.55 [N₂H₄]. Reagents Solution: [DMACA]=5×10⁻³ M, [PSS]=3.68 g·L⁻¹, i.e. r=[H⁺]/[DMACA]=4 and the Isobestic Point at 542 nm

Four examples of application of the analytical method are given here. Mixtures of known concentrations of N₂H₄, NH₂EtOH and NH₃ with ratios of [NH₃]/[N₂H₄]=96.55 and [NH₂EtOH]/[N₂H₄]=96.55 were prepared and the spectra of the mixtures were collected at 24 h. These spectra were analyzed by collecting absorbance values at the specific wavelengths, 542 nm and 474 nm, to deduce the concentrations of N₂H₄ and NH₂EtOH. The calculated values were then compared with theoretical concentration values (Table 3).

TABLE 3
Blind assay results for NH₂EtOH and N₂H₄ with r = 4 in the mixture
containing NH₃, N₂H₄ and NH₂EtOH. [NH₃] = [NH₂EtOH] = 96.55 ×
[N₂H₄], [DMACA] = 5 × 10⁻³M, [PSS] = 3.68 g · L⁻¹,
i.e. r = [H⁺]/[DMACA] = 4, quartz cell with 1 cm optical path
length. Deviation = ((calculated value − theoretical value)/theoretical value).

| | [NH₃] | [N₂H₄] (×10⁻⁶M) | | | [NH₂EtOH] (×10⁻⁴M) | | |
|---|---|---|---|---|---|---|---|
| | (×10⁻⁴M) | Calculation | | Deviation | Calculation (24 h) | | Deviation |
| | Theoretical | (Δ = ±7%) | Theoretical | (%) | (Δ = ±7%) | Theoretical | (%) |
| Ex. 1 | 5.84 | 5.81 | 6.05 | −3.9 | 4.84 | 5.84 | −17.4 |
| Ex. 2 | 4.78 | 4.95 | 4.95 | +0.1 | 3.99 | 4.78 | −16.6 |
| Ex. 3 | 3.72 | 3.92 | 3.85 | +1.9 | 3.07 | 3.72 | −17.3 |
| Ex. 4 | 2.66 | 2.79 | 2.75 | +1.5 | 2.00 | 2.66 | −24.7 |

As for Examples 1 and 2, this example demonstrates the very good reliability of the process according to the invention, in particular as regards the detection and quantification of hydrazine, since very small deviations (less than 4%) are observed between the calculated and theoretical values.

This example also demonstrates the very good sensitivity of the process as regards the detection and quantification of hydrazine, since the concentrations calculated by means of the process are very close to the theoretical concentrations despite interferent concentrations (NH₃ and NH₂EtOH) almost 100 times greater than that of hydrazine.

### Example 7: Aqueous Solution Measurements of N₂H₄ in the Presence of Interferents on Industrial Sites

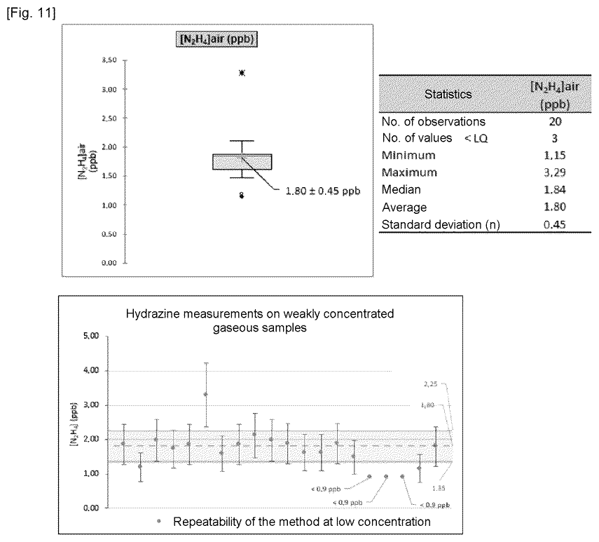

Liquid hydrazine measurements were taken on four samples collected on an industrial site. In addition to hydrazine, the samples also contained other amines such as NH₂EtOH+NH₃ or morpholine+NH₃ in varying concentrations. The results of the measurements taken were systematically compared with the automated amperometric measurements produced on the sampled lines, and with the measurements taken with the pDMAB (p-dimethylaminobenzaldehyde) reagent. FIG. 10 shows the set of results obtained.

This example shows that the process according to the invention afforded hydrazine concentration results very close to those obtained via the known method using pDMAB. Specifically, concentration differences of less than 2 μg/L are observed between the two methods.

### Example 5: Application of the Process According to the Invention to the Determination of Gaseous N₂H₄ and NH₂EtOH in Ambient Air Containing Different Analyte Concentrations and in the Presence of a Strong Base, NH₃ with 85 [N₂H₄]<[NH₃]<116 [N₂H₄]. Reagents Solution: [DMACA]=5×10⁻³ M, [PSS]=9.2 g·L⁻¹, i.e. r=[H⁺]/[DMACA]=10

Five examples of application of the method are given here. Mixtures of known concentrations of N₂H₄, NH₂EtOH and NH₃ with different ratios of [NH₃]/[N₂H₄] and [NH₂EtOH]/[N₂H₄] were prepared. The air to be analyzed was pumped at a flow rate of 1 L·min⁻¹ and bubbled through 50 mL of reagent for 1 h. The spectra of the mixtures were collected at 24 h. These spectra were analyzed by collecting the absorbance values at the specific wavelengths, 553 and 474 nm, to deduce the concentrations of N₂H₄ and NH₂EtOH. The calculated values were then compared with the theoretical concentration values (Table 4).

TABLE 4

| | | | | [N₂H₄] ppb | | | [NH₂EtOH] ppm | | |
|---|---|---|---|---|---|---|---|---|---|
| | $\frac{[ {NH}_{3} ]}{[ {N}_{2} {H}_{4} ]}$ | $\frac{[ {NH}_{2} Et OH ]}{[ {N}_{2} {H}_{4} ]}$ | [NH₃] ppm Theoretical | Calculation (Δ = ±7%) | Theoretical (Δ = ±8%) | Devi- ation (%) | Calculation (24 h) (Δ = ±7%) | Theo- retical | Devia- tion (%) |
| Ex. 1 | | 99 | 1 | 10.6 | 9.6 | 10.8% | | 0.95 | |
| Ex. 2 | | 111 | 5 | 37.2 | 43 | −13.5% | 4.79 | 4.76 | 0.6% |
| Ex. 3 | 93 | 88 | 5 | 61.5 | 54 | 13.9% | 4.35 | 4.76 | −8.6% |
| Ex. 4 | 87 | 45 | 18.3 | 229.8 | 211 | 8.9% | 9.1 | 9.52 | −4.4% |
| Ex. 5 | 85 | 81 | 10 | 137.7 | 117 | 17.7% | 9.6 | 9.52 | 0.8% |

Assay results for gaseous N₂H₄ and NH₂EtOH in the mixture containing NH₃, N₂H₄ and NH₂EtOH, with 50 mL of reagent containing [DMACA] = 5 × 10⁻³M, [PSS] = 9.2 g.L⁻¹, i.e. r = [H⁺]/[DMACA] = 10, quartz cell with 1 cm optical path length. T º = 22º C. Deviation = (calculated value − theoretical value)/theoretical value.

This example demonstrates the very good reliability of the process according to the invention applied to a gaseous sample, in particular as regards the detection and quantification of hydrazine, since small deviations (less than 18%) are observed between the calculated and theoretical values.

This example also demonstrates the very good sensitivity of the process of the invention applied to a gaseous sample as regards the detection and quantification of hydrazine, since the concentrations calculated by means of the process are very close to the theoretical concentrations despite proportions of interferents (NH₃ or NH₂EtOH) up to 100 times greater than that of hydrazine.

### Example 6: Application of the Process According to the Invention to the Determination of N₂H₄ in Ambient Air Containing Different Concentrations of Gaseous Morpholine Analytes and in the Presence of a Strong Base, NH₃ with 57 [N₂H₄]<[NH₃]<164 [N₂H₄]. Reagents Solution: [DMACA]=5×10⁻³ M, [PSS]=9.2 g·L⁻¹, i.e. r=[H⁺]/[DMACA]=10

Seven examples of application of the method are given here. Mixtures of known concentrations of N₂H₄, morpholine and NH₃ with different ratios of [NH₃]/[N₂H₄] and [morpholine]/[N₂H₄] were prepared on an experimental gas bench. The air to be analyzed was pumped at a flow rate of 1 L·min⁻¹ and bubbled through 50 mL of reagent for 1 h. The spectra of the mixtures were collected at 1 h. These spectra were analyzed by collecting the absorbance values at the specific wavelengths, 553 and 487 nm, to deduce the concentrations of N₂H₄ and morpholine. The calculated values are then compared with theoretical concentration values (Table 5).

TABLE 5

| | | | | [N₂H₄] ppb | | | [morpholine] ppm | | |
|---|---|---|---|---|---|---|---|---|---|
| | [NH₃] [N₂H₄] | $\frac{[ morpholine ]}{[ {N}_{2} {H}_{4} ]}$ | [NH₃] ppm Theoretical | Calculation (Δ = ±7%) | Theoretical (Δ = ±8%) | Devia- tion (%) | Calculation (1 h) (Δ = ±7%) | Theo- retical | Devia- tion (%) |
| Ex. 1 | 138 | 146 | 9 | 71 | 65 | 9.2% | 8.8 | 9.5 | −7.4% |
| Ex. 2 | 138 | 66 | 9 | 71 | 65 | 9.2% | 4.4 | 4.3 | 2.3% |
| Ex. 3 | 109 | 113 | 10.8 | 103.5 | 99.2 | 4.3% | 11.5 | 11.2 | 2.7% |
| Ex. 4 | 76 | 79 | 7.5 | 102.1 | 99.2 | 2.9% | 7.9 | 7.8 | 1.3% |
| Ex. 5 | 164 | 170 | 8.3 | 54.2 | 50.5 | 7.3% | 8.3 | 8.6 | −3.5% |
| Ex. 6 | 99 | 103 | 5 | 52.8 | 50.5 | 4.6% | 4.6 | 5.2 | 11.5% |
| Ex. 7 | 57 | 46 | 1.6 | 32.8 | 28.3 | 15.9% | 1.1 | 1.3 | −15.4% |

Results of N₂H₄ assay in the mixture containing NH₃, N₂H₄ and morpholine, with 50 mL of reagents containing [DMACA] = 5 × 10⁻³M, [PSS] = 9.2 g.L⁻¹, i.e. r = [H⁺]/[DMACA] = 10, quartz cell with 1 cm optical path length. T º = 22º C. Deviation = (calculated value − theoretical value)/theoretical value.

As for Example 5, this example demonstrates the very good reliability of the process according to the invention applied to a gaseous sample, in particular as regards the detection and quantification of hydrazine, since small deviations (less than 16%) are observed between the calculated and theoretical values.

This example also demonstrates the very good sensitivity of the process according to the invention applied to a gaseous sample as regards the detection and quantification of hydrazine, since the concentrations calculated by means of the process are very close to the theoretical concentrations despite proportions of interferents (NH₃ or morpholine) up to 170 times greater than that of hydrazine.

### Example 9: Examples of Gaseous N₂H₄ Measurements at Two Concentration Levels

Air samples were taken from the gaseous headspace of two closed tanks containing a concentrated hydrazine solution. The concentrations of hydrazine in the liquid phase are not precisely known, but are estimated at 1% by weight.

The aim of the present experiment is to study the reproducibility of the process according to the invention for the quantification of hydrazine in a gaseous sample, as the hydrazine concentration in this sample is not known.

The duration of sampling and sparging in the reagents solution (DMACA/PSS with r=10) is 1 hour.

| | [N₂H₄]ₐᵢᵣ | | Standard | [N₂H₄]ₐᵢᵣ | | Standard |
|---|---|---|---|---|---|---|
| | (μg/m³) | ± | deviation | (ppb) | ± | deviation |
| Tank 1 | 89 | ± | 13 | 67 | ± | 10 |
| Tank 2 | 70 | ± | 8 | 53 | ± | 6 |

This experiment demonstrates the good reproducibility of the hydrazine quantification process in a gaseous sample, since the standard deviations reported in the above table are low.

With the object of evaluating the reproducibility of the method on samples of lower concentration, 20 samples were taken at a distance of 7 meters from the abovementioned tank 1, which was covered with a non-leaktight lid. These samples were taken under identical experimental conditions. Hydrazine concentrations of 1.80 ppb were measured. FIG. 11 shows the distribution of the results obtained for all the samples produced.

This experiment demonstrates the very good repeatability of the process according to the invention applied to a gaseous sample with a low hydrazine concentration since, with the exception of one measurement, all the results show measurement variations of less than 0.5 ppb, which is really minimal.

### LIST OF CITED DOCUMENTS

[1] G. W. Watt, J. D. Chrisp, A Spectrophotometric Method for the Determination of Hydrazine, Anal. Chem., 24 (12), 2006-2008, 1952.
[2] C. Gojon, B. Dureault, Spectrophotometric study of the reaction between hydrazine and p-dimethylaminobenzaldehyde, Journal of Nuclear Science and Technology, 33 (9), pages 731-735, 1996.
[3] S. Ganesh, F. Khan, M. K. Ahmed, P. Velavendan, N. K. Pandey, U. K. Mudali, Spectrophotometric Determination of Hydrazine with Para-(Dimethylamino) Benzaldehyde in Aqueous Streams of Purex Process, IJNESE, 2 (1), 2012.
[4] M. George, K. S. Nagaraja, N. Balasubramanian, Spectrophotometric determination of hydrazine, Talanta, 75, pages 27-31, 2008.
[5] P. Ortega-Barrales, A. Molina-Diaza, M. I. Pascual-Reguera, L. F. Capith-Vallvey, Solid-phase spectrophotometric determination of trace amounts of hydrazine at sub-ng ml-1 level, Analytica Chimica Acta, 353, pages 115-122, 1997.
[6] S. Amlathe, V. K. Gupta, Spectrophotometric Determination of Trace Amounts of Hydrazine in Polluted Water, Analyst, 113, pages 1481-1483, 1988.
[7] R. Kaveeshwar, V. K. Gupta, A new spectrophotometric method for the determination of hydrazine in environmental samples, Fresenius J. Anal. Chem., 344, pages. 114-117, 1992.
[8] J. Manes, P. Campillos, G. Font, Extraction—Spectrophotometric Determination of Hydrazine with 2-Hydroxy-1-Naphthaldehyde, ANALYST, 112, pages 1183-1184, 1987.
[9] D. S. Kosyakova, A. S. Amosov, N. V. UI'yanovskii, A. V. Ladesov, Yu. G. Khabarov, O. A. Shpigun, Spectrophotometric Determination of Hydrazine, Methylhydrazine, and 1,1-Dimethylhydrazine with Preliminary Derivatization by 5-Nitro-2-Furaldehyde, Journal of Analytical Chemistry, 72 (2), pages 171-177, 2017.
[10] B. Roy, S. Bandyopadhyay, The design strategies and mechanisms of fluorogenic and chromogenic probes for the detection of hydrazine, Anal. Methods, 10, pages 1117-1139, 2018.
[11] K. H. Nguyen, Y. Hao, W. Chen, Y. Zhang, M. Xu, M. Yang, Y.-N. Liu, Recent progress in the development of fluorescent probes for hydrazine, Luminescence, 33, pages 816-836, 2018.
[12] Y. Jung, I. G. Ju, Y. H. Choe, Y. Kim, S. Park, Y.-M. Hyun, M. S. Oh, D. Kim, Hydrazine Exposé: The Next-Generation Fluorescent Probe, ACS Sens., 4, 441-449, 2019.
[13] Shweta, A. Kumar, Neeraj, S. K. Asthana, A. Prakash, J. K. Roy, I. Tiwari, K. K. Upadhyay, A highly sensitive naphthaoxazole-based cell-permeable ratiometric chemodosimeter for hydrazine, RSC Adv., 6, pages 94959-94966, 2016.
[14] L. Cui, Z. Peng, C. Ji, J. Huang, D. Huang, J. Ma, S. Zhang, X. Qian, Y. Xu, Hydrazine detection in the gas state and aqueous solution based on the Gabriel mechanism and its imaging in living cells, Chem. Commun., 50, 1485-1487;
[15] X. Xia, F. Zeng, P. Zhang, J. Lyu, Y. Huang and S. Wu, An ICT-based ratiometric fluorescent probe for hydrazine detection and its application in living cells and in vivo, Sens. Actuators B Chem., 227, pages 411-418, 2016.
[16] A. Afkhami, A. Afshar-E-Asl, Kinetic-spectophotometric determination of hydrazine by the inhibition of the bromate-hydrochloric acid reaction, Analytica Chimica Acta, 419, pages 101-106, 2000.
[17] V. D. Mitic, S. D. Nikolic, V. P. Stankov-Jovanovic, Kinetic spectrophotometric determination of hydrazine, Cent. Eur. J. Chem., 8(3), pages 559-565, 2010.
[18] W. Gao, J. Xi, Y; Chen, S. Xiao, Y. Lin, Y. Chen, A facile and one-step colorimetric determination of hydrazine during formation of size-controlled amidosulfonic acid capped gold nanoparticles, Anal. Methods, 4, pages 3836-3840, 2012.
[19] B. Zargar, A. Hatamie, A simple and fast colorimetric method for detection of hydrazine in water samples based on formation of gold nanoparticles as a colorimetric probe, Sensors and Actuators B 182, pages 706-710, 2013.
[20] Z. Zhao, G. Zhang, Y. Gao, X. Yang, Y. Li, A novel detection technique of hydrazine hydrate: modality change of hydrogen bonding-induced rapid and ultrasensitive colorimetric assay, Chem. Commun., 47, 12816-12818;
[21] S. Dorostkar, B. Hemmateenejad, Label-free colorimetric detection of picomolar amounts of hydrazine using a gold nanoparticle-based assay, J. Iran Chem. Soc., 10, pages 513-519, 2013.
[22] J. Tashkhourian, M. R. Hormozi-Nezhad, M. Fotovat, Optical Detection of Some Hydrazine Compounds Based on the Surface Plasmon Resonance Band of Silver Nanoparticles, Spectroscopy Letters, 46, pages 73-80, 2013.
[23] Toxicology data sheet No. 21 INRS http://www.inrs.fr/publications/bdd/fichetox/fiche.html?refINRS=FICHETOX_21
[24] Air quality. Workplace air. Sampling and analyzing organic vapors. Sampling by pumping through a solvent adsorption and desorption tube. Standard NF X 43-267. La Plaine Saint Denis: AFNOR; 2004.
[25] Métropole Hydrazine M-7 data sheet, http://www.inrs.fr/publications/bdd/metropol/fiche.html?reflNRS=METROPOL_7
[26] Hydrazine. Method 108 In: Sampling and Analytical methods. OSHA, 1997 (https://www.osha.gov/dts/sltc/methods/organic/org108/org108.html) or (https://www.osha.gov/sites/default/files/methods/osha-108.pdf)
[27] B. J. Meneghelli, A review of hydrazine sensors: The state of the art, ASRC Aerospace Corp, Cocoa Beach, FL, United States, 2004.
[28] K. P. Brenner, S. L. Rose-Pehrsson, Performance Evaluation of a Colorimetric Hydrazine Dosimeter, 1994.
[29] https://dodtec.com/hydrazine-mmh-dose-estimator.html
[30] https://www.chemsee.com/commercial/toxic-gas/available-products/dosimeters/hyd-009-dosimeter-for-hydrazine/
[31] Rose-Pehrsson et aL., patent U.S. Ser. No. 00/571,9061 A
[32] http://catalog.gasdetection.com/item/search-by-gas-type-hydrazine-s-/nalyzer-4000-series-with-digital-display-hydrazine/4180-100b
[33] https://www.raefrance.fr/produit/detecteur-cov-capteur-pid-ppbrae-3000/
[34] https://www.cbrnetechindex.com/p/3525/Smiths-Detection-Inc/Sabre-4000
[35] https://www.environics.fi/product/chempro100i/
[36] https://www.masatech.eu/portable-advanced-ion-mobility-spectrometer
[37] https://www.smithsdetection.com/products/lcd-3-3/

1. A process for detecting in a sample to be analyzed at least one amine-type compound, said compound being chosen from hydrazine, ethanolamine, ammonia and morpholine, using a reagents composition comprising a mixture of 4-(dimethylamino)cinnamaldehyde and polystyrenesulfonic acid, said process comprising the steps of:
a) mixing said sample to be analyzed with said reagents composition to obtain a mixture consisting of the sample to be analyzed and said reagents composition, and
b) detecting said amine-type compound(s) in the mixture consisting of the sample to be analyzed and said reagents composition.

2. The process according to claim 1, wherein step b) further comprises quantifying said amine-type compound(s) in the mixture consisting of the sample to be analyzed and said reagents composition.

3. The process according to claim 1, wherein the sample to be analyzed is a liquid or gaseous sample or an aerosol.

4. The process according to claim 1, wherein the detection or detection and quantification step b) is performed by measuring the absorbance as a function of time of the mixture consisting of the sample to be analyzed and said reagents composition.

5. The process according to claim 1, wherein the ratio r of the concentrations of 4-(dimethylamino)cinnamaldehyde and polystyrenesulfonic acid is from 1 to 20.

6. A reagents composition comprising a mixture of 4-(dimethylamino)cinnamaldehyde and polystyrenesulfonic acid.

7. The composition according to claim 6, wherein the ratio r of the concentrations of 4-(dimethylamino)cinnamaldehyde and polystyrenesulfonic acid is from 1 to 20.

8. A method for detecting at least one amine-type compound, comprising mixing a sample with the reagents composition according to claim 6, said compound being chosen from hydrazine, ethanolamine, and morpholine.

9. A method for quantifying at least one amine-type compound, comprising mixing a sample with the reagents composition according claim 6, said compound being chosen from hydrazine, ethanolamine and morpholine.

10. A kit for preparing the reagents composition according to claim 6, said kit comprising:
a first container comprising 4-(dimethylamino)cinnamaldehyde; and
a second container comprising an aqueous solution of polystyrenesulfonic acid.
